(19) United States
(12) Patent Application Publication
(10) Pub. No.: US 2017/0031030 A1
(43) Pub. Date: Feb. 2, 2017

(54) DEVICE AND METHOD FOR MEASURING DISTANCES ON A GOLF COURSE

(71) Applicant: Brian Christopher Verdugo, Laguna Niguel, CA (US)

(72) Inventor: Brian Christopher Verdugo, Laguna Niguel, CA (US)

(73) Assignee: L1 Technologies, Inc., San Diego, CA (US)

(21) Appl. No.: 15/001,213

(22) Filed: Jan. 19, 2016

Related U.S. Application Data
(60) Provisional application No. 62/199,333, filed on Jul. 31, 2015.

(51) Int. Cl. G01S 19/26; G01S 17/02; G01S 19/19; G01S 19/34

(52) U.S. Cl. CPC G01S 19/26; G01S 19/34; G01S 17/023; G01S 19/19

(57) ABSTRACT

A distance measuring device and method are disclosed for use on a golf course. A satellite navigation system receiver determines a user's location. A database containing stored coordinates is accessed by a processor to determine a golf course and a hole associated with the location and a maximum and a minimum distance from the location to a green containing the hole. A laser rangefinder determines a distance between the location and each of a plurality of objects. The processor discards object distances which are not within the perimeter of the green. Optionally, an accelerometer and a gyrometer are used to more precisely determine a heading of the laser pulse for each object distance. The processor establishes from the stored coordinates a cone of interest originating at the location and extending to the green, and discards object distances which do not have headings within the cone of interest. The retained distance may be displayed for the user.

### 1.0 TECHNICAL FIELD

The present invention relates to distance measuring devices, and, more particularly but not exclusively, to rangefinders used in golfing.

### 2.0 BACKGROUND

Golfers often use handheld rangefinders to determine distances to objects on the course such as the pin flag, in order to select the appropriate golf club and approach a shot correctly. Typically such rangefinders employ a laser. When a golfer activates a laser rangefinder to determine the distance to the pin, the laser may not accurately identify the correct object to use in the measurement.

In a conventional laser rangefinder, the system sends out several pulses which are reflected by objects they hit. If a number of reflected pulses come back at a particular distance, and that number is over a threshold, then the laser knows that the object is the intended target and reports the distance. So for example, the laser may send out 100 pulses and if 70 come back at a particular distance, then the rangefinder may conclude that the distance to the intended target has been measured and can be reported.

This approach works well at short distances. However, at long distances (say 200 yards from the pin flag), it becomes difficult to maintain the laser scope centered on the flag. Many golfers, especially older golfers, have difficulty holding the rangefinder steady enough for an accurate reading over large distances. Even slight shaking will cause the laser to hit too many other objects on the course besides the pin flag, e.g. trees and rocks. The reflected pulses that return to the rangefinder then do not meet the necessary thresholds. Therefore the laser rangefinder is of limited use.

### 3.0 SUMMARY

The present invention eliminates the drawbacks of a conventional laser rangefinder by providing a distance measuring device which is able to filter out extraneous objects in the field of view that may confuse the laser and prevent it from identifying the pin flag to determine a correct range measurement. The distance measuring device and method disclosed are accurate over longer distances than current rangefinders and shaking of the user's hand does not impact the measurement.

One embodiment uses a conventional laser rangefinder in conjunction with a global positioning system (GPS) receiver and a database containing coordinate information for many golf courses around the world. The database includes coordinates for the perimeter of the green in addition to the front, back, left edge and right edge of each green at every course. The hole or pin, which contains a flag, is always within the circumference of the green, and the pin flag is usually the only vertical object in the green. When the laser scans the green and detects an object at a distance that lies within the circumference or polygon defined by the green coordinates (front, back, left and right), then the rangefinder has confidence that the detected object is the pin flag and can output the distance.

In another embodiment, the rangefinder optionally further includes an accelerometer and gyrometer. Through the GPS, the current location of the rangefinder held by a user is known. By accessing the database of golf course coordinates, the coordinates of the green are also known. From this information, the system can compute the minimum and maximum distances from the user holding the rangefinder to the pin flag. While the GPS receiver can also provide heading information i.e., the direction that rangefinder 15 is pointing—the rangefinder may optionally include an accelerometer and gyrometer, which allows for a more precise determination of the heading. This makes the rangefinder more robust by allowing the calculation of a cone of interest that has its origin at the user's location and extends to the green. Because golf courses generally do not have vertical objects on the fairway approach to the green, any other vertical objects that may cause false detection are behind the green, and thus it may not be necessary to include an accelerometer and a gyrometer.

A laser rangefinder is typically a monocular that a user sights through to locate the pin flag. The laser device then performs the calculation to determine the range, and the results from the calculation can be presented within the laser sight optics (i.e., the user will see the information when looking through the device). Because a GPS receiver is power consuming since it is always receiving satellite signals to determine its position, the rangefinder may optionally allow the GPS feature to be turned off when the battery is low, thus converting the system into a laser-sight only device. This is still useful, but does not have GPS to more accurately identify the pin flag location.

The foregoing summary is illustrative only and is not meant to be exhaustive. Other aspects, objects, and advantages of this invention will be apparent to those of skill in the art upon reviewing the drawings, the disclosure, and the appended claims.

### 4.0 BRIEF DESCRIPTION OF THE DRAWINGS

Various aspects of certain example embodiments can be better understood with reference to the following figures. The components shown in the figures are not necessarily to scale, emphasis instead being placed on clearly illustrating example aspects and features. In the figures, like reference numerals designate corresponding parts throughout the different views and embodiments. Certain components and details may be omitted from the figures to improve clarity.

FIG. 1 illustrates a user sighting through a rangefinder.

FIG. 2 shows components of the rangefinder.

FIG. 3 illustrates a golf course with locations used by the rangefinder.

FIG. 4 illustrates a golf course with objects that may be considered targets by a laser.

FIG. 5 illustrates a golf course with the cone of interest of the rangefinder.

FIG. 6 shows the steps in a first method for measuring distances at a golf course.

FIG. 7 shows the steps in a second method for measuring distances at a golf course.

### 5.0 DETAILED DESCRIPTION OF EXAMPLE EMBODIMENTS

Following is a written description illustrating various aspects of non-limiting example embodiments. These examples are provided to enable a person of ordinary skill in the art to practice the full scope of the invention, including different examples, without having to engage in an undue amount of experimentation. As will be apparent to persons skilled in the art, further modifications and adaptations can be made without departing from the spirit and scope of the invention, which is limited only by the claims.

In the following description, numerous specific details are set forth in order to provide a thorough understanding. Particular example embodiments may be implemented without some or all of the disclosed features or specific details. Additionally, to improve clarity of the disclosure some components well known to persons of skill in the art are not described in detail.

FIG. 1 shows a user 10 sighting through the rangefinder 15. The user 10 looks through a viewer 35 toward an object along the sightline 20. Using the control panel 18, the user 10 may send laser pulses 25 from the rangefinder 15 toward the object. After hitting the object, the reflected pulses 30 return to the rangefinder 15, where the distance to the object may be output to the viewer 35 so that the user 10 may read it.

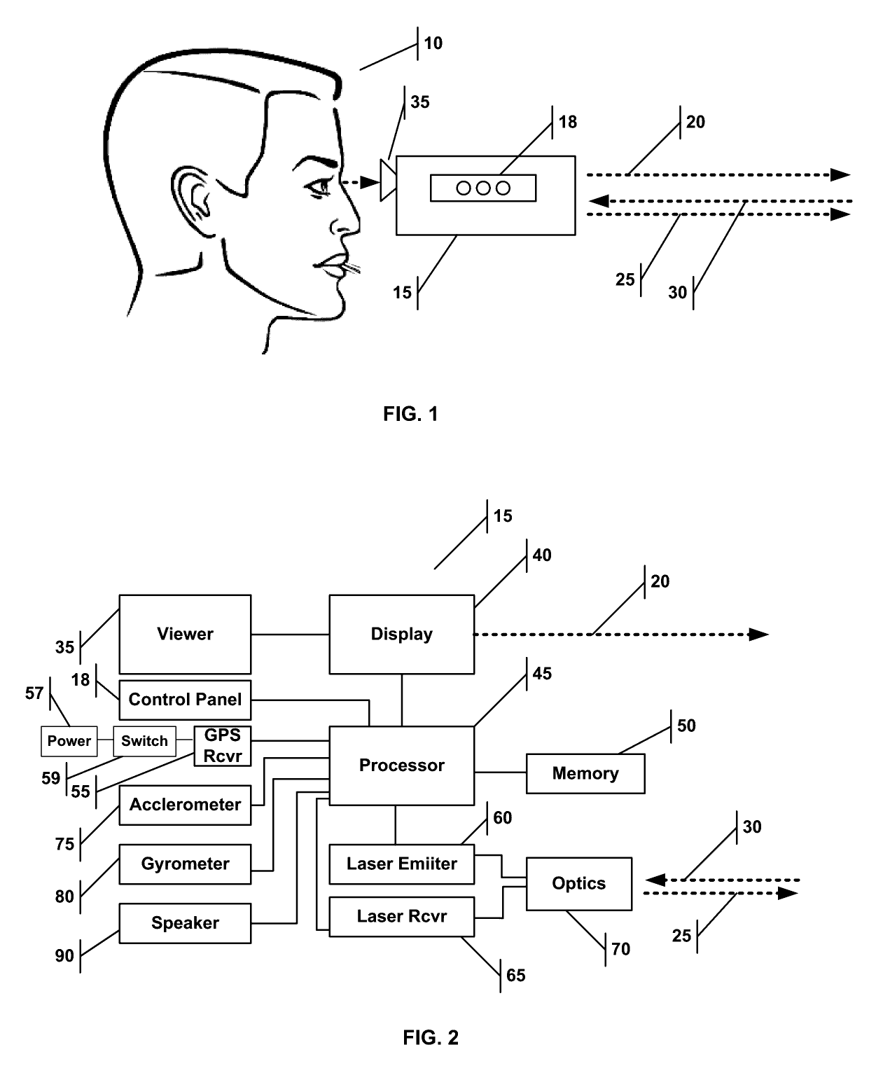

The rangefinder 15 is illustrated with greater detail in FIG. 2. A viewer 35 is linked to a display 40 where information may be presented to the user, and also allows the user a forward view 20 toward objects on the golf course. The user controls operation of the rangefinder 15 through the control panel 18, which allows operation of functions such as on/off, current position finding, and laser sighting. A laser emitter 60 is operable to send pulses 25 through the optics 70, which bounce off an object or objects sighted by the user and return as reflected pulses 30 through the optics 70 and into the laser receiver 65, for use in determining a distance from the object. The rangefinder 15 also includes a GPS receiver 55 which can determine its current position by accessing a satellite navigation system. The GPS receiver 55 may be turned off by the user via a switch 59 connected to the battery 57 in order to conserve power. Since the GPS receiver 55 is continuously communicating with satellites to determine its location, it may drain the battery 57 more quickly than desired if left on continuously. The switch 59 may be a part of the control panel 18. While the GPS receiver 55 can also provide heading information i.e., the direction that rangefinder 15 is pointing—the rangefinder 15 may optionally include an accelerometer 75 and gyrometer 80, which allows for a more precise determination of the heading of the pulses 25. A speaker 90 may also be included to provide audio output to the user.

A computer processor 45 communicates with the GPS receiver 55 to access a memory 50, which holds a database of stored latitude and longitude information for each green in a large number of golf courses, including coordinates of a polygon defining the edges of every green: front, back, left, and right. The processor 45 is also linked to the laser receiver 65 to access information to determine object distance based on reflected pulses 30, and to the optional accelerometer 75 and gyrometer 80 to access information to determine object heading, in a manner that will be described further below. The processor 45 operates in accordance with commands delivered by the user via the control panel 18, and outputs information to the display 40 and/or the optional speaker 90.

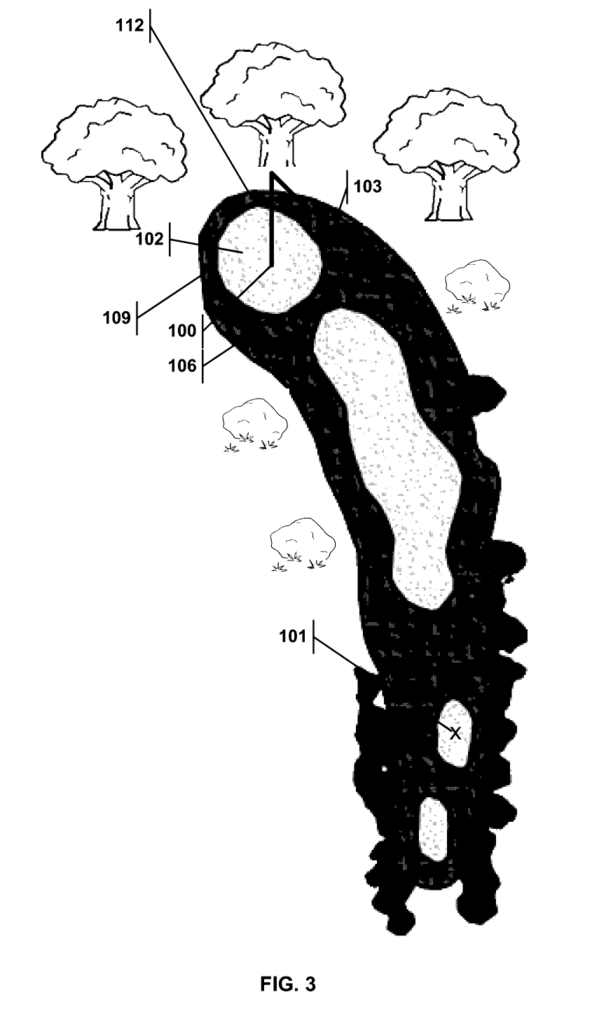

The operation of the rangefinder 15 is as follows. Referring also to FIG. 3, the GPS receiver 55 communicates with the satellite navigation system to determine the current position 101 of the user holding the rangefinder 15. The processor 45 uses position 101 as a reference to search the memory 50 for a corresponding golf course and a green within that golf course, and identifies the perimeter latitude and longitude coordinates of at least the points at the right edge 103, front edge 106, left edge 109 and back edge 112 of the green 102. From this information, the processor 45 determines the inner area of the polygon representing the location of the green 102. The processor 45 also determines the maximum and minimum distances from the current position 101 to the green 102, i.e., the distances from position 101 to the front 106 and to the back 112 of the green 102. For instance, the front 106 of the green 102 might be at 330 yards from the user's position 101, while the back 112 might be at 375 yards. Because the pin flag 101 lies within the polygon and between the maximum and minimum distances from the green 102, the rangefinder 15 knows, at least as a first past, the range at which sighted objects could possibly be the pin flag 100, e.g. between 330 and 375 yards.

While the operation of the rangefinder 15 was just described with reference to only four coordinates defining the green i.e., the right edge 103, front edge 106, left edge 109 and back edge 112—the memory 50 would, in most circumstance, include several additional latitude and longitude coordinates that define the perimeter of the green. The benefit of having multiple coordinate over the right, left, front and back edges is that the processor 45 can more accurately determine the inner area of the polygon.

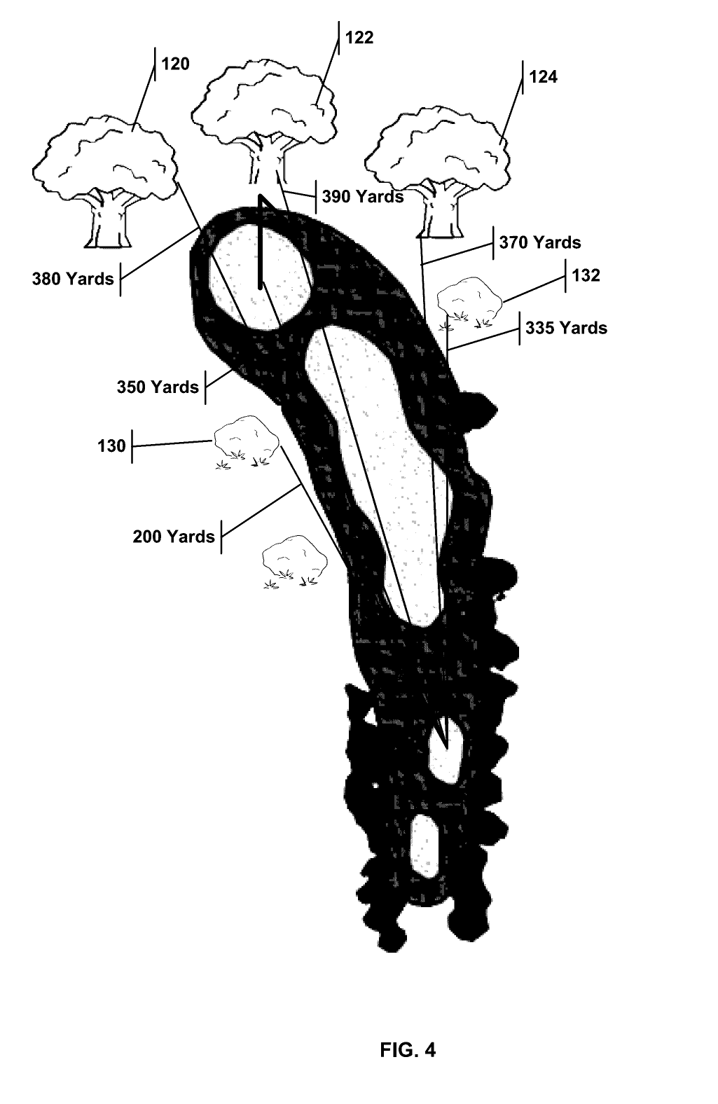

The user 10 activates the laser emitter 60 via the control panel 18 to send laser pulses 25 through optics 70 toward the pin flag 100 on the green 102, which return to the laser receiver 65 as reflected pulses 30 after passing through optics 70. The processor 45 determines the distance to each of the objects in the conventional manner of laser rangefinders. Unfortunately, the laser pulses 25 may reflect from objects other than the pin flag 100 to cause false range readings. For example, as shown in FIG. 4, they may reflect from the pin flag 100 at 350 yards, but also from a rock 130 to the left at 200 yards, a tree 120 at 380 yards, a tree 122 behind the green at 390 yards, a tree 124 to the right at 370 yards, and a rock 132 at 335 yards from the user's position 101. Because the rangefinder 15 knows that the pin flag 100 lies on the green between 330 and 375 yards away, the processor can discard the distances to the rock 130 and to the trees 120 and 122 as they do not represent possible distances to the pin flag 100. However, the distances to the tree 124 and to the rock 132 lie between the maximum and minimum distances to the green and cannot be eliminated on this basis.

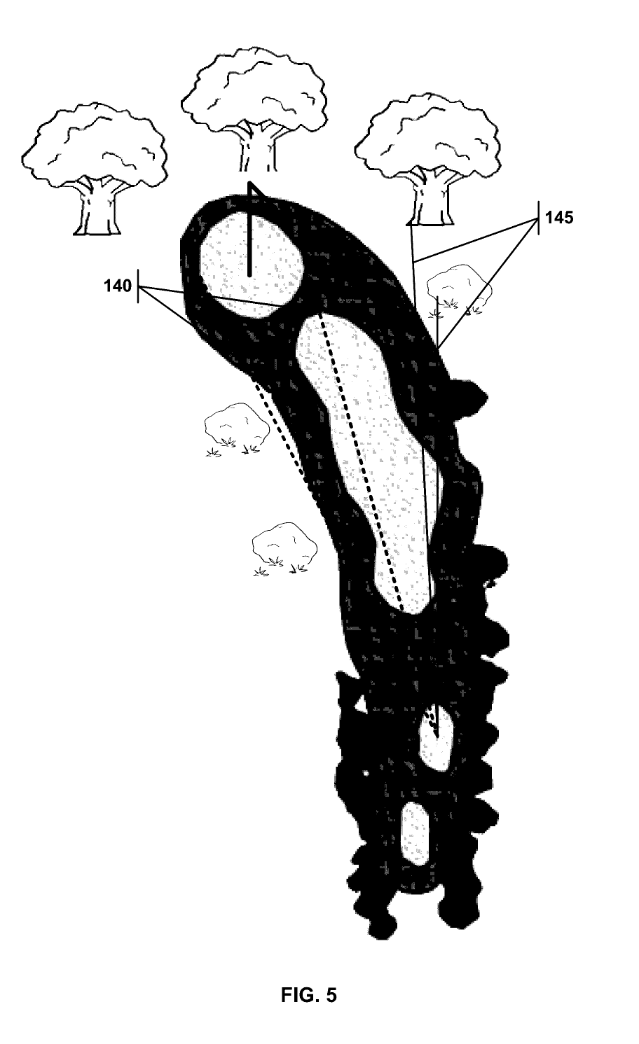

The rangefinder 15 also knows the locations of the right edge 103 and left edge 109 of the green 102 and the processor 45 uses this information to construct a cone of interest 140 originating at the user's position 101 and extending through the edges 103 and 109 of the green 102, as shown in FIG. 5. Again this in an oversimplification because the memory 50 will include several points that define the edge of the green, within which the pin/hole will be located. Using an optional accelerometer 75 and gyrometer 80, the heading (azimuth and elevation) of the laser pulses 25 may be more precisely identified and communicated to the processor. Because the extraneous objects 145 (the tree 124 and the rock 132) do not have headings that fall within the cone of interest 140, those object distances may be eliminated.

The remaining object distance, after the extraneous object distances have been discarded, must represent the pin flag 100 at 350 yards. The processor 45 outputs this information to the display 40, and the user 10 may have confidence that the value shown represents the correct distance to the pin flag 100 as determined by the laser pulses.

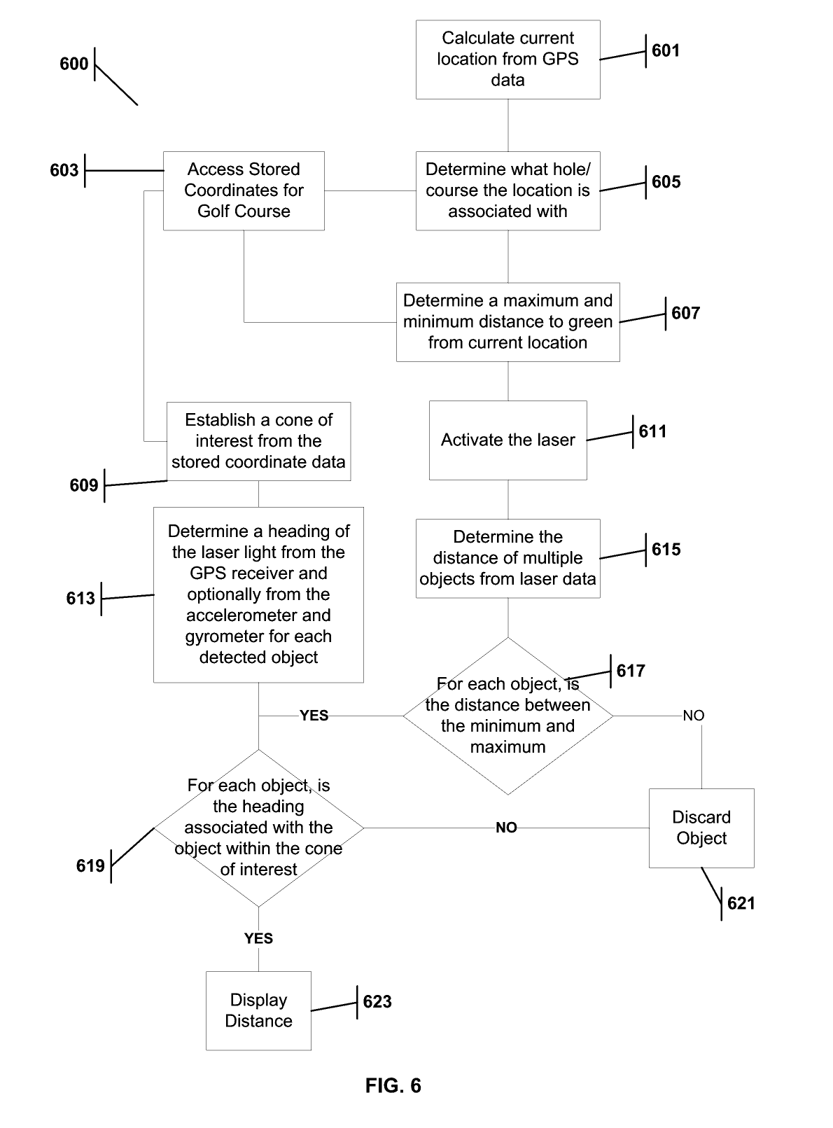

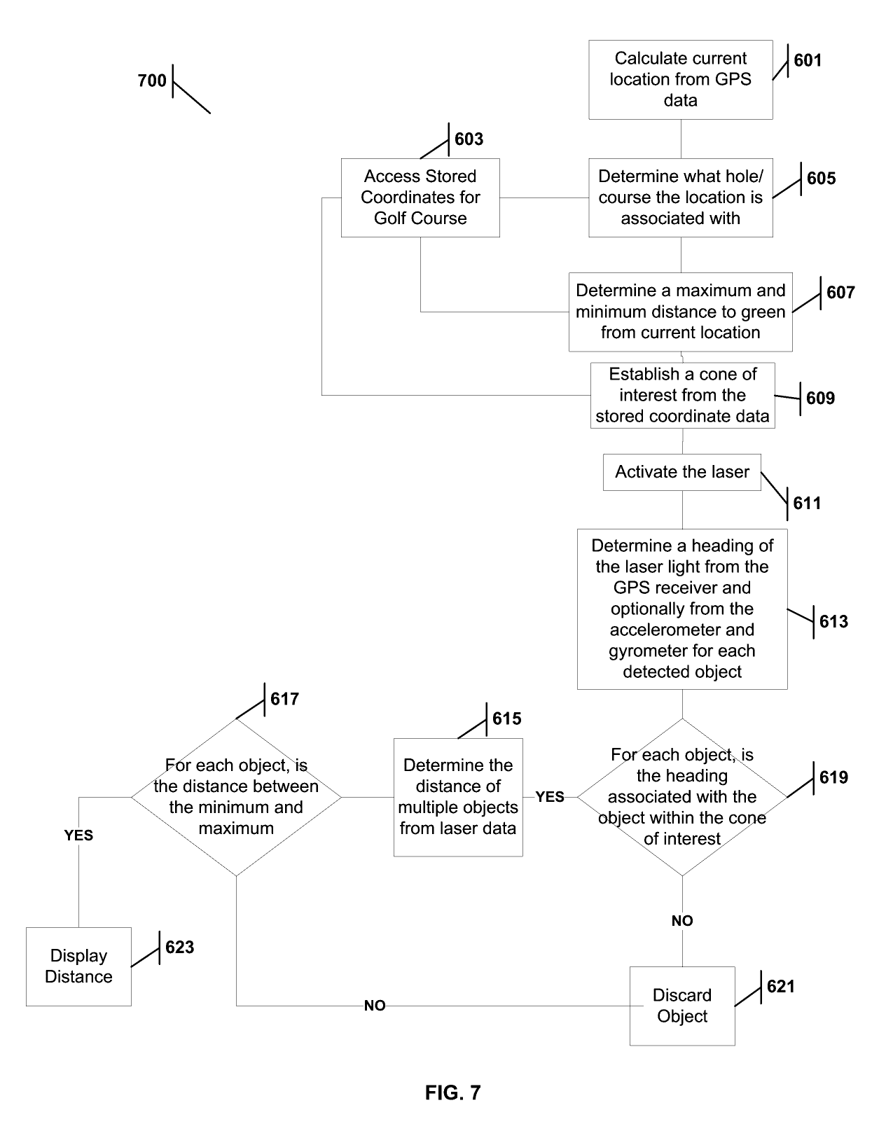

FIG. 6 provides the steps in a method 600 for measuring distances at a golf course. First, the current location is calculated from GPS data at step 601. Stored coordinates for the golf course are accessed at step 603 to determine which hole on which golf course is associated with the location (step 605) and the maximum and minimum distances from the location to the perimeter of the green surrounding the particular hole (step 607), and further to establish a cone of interest to the green originating at the location (step 609). The laser is activated to emit pulses at step 611 and, at step 615, the distances of multiple objects from the location are determined from the reflected pulses. In a parallel (and optional) step 613, a heading of the laser pulse is determined for each object using the GPS receiver, the accelerometer and/or a gyrometer. For each object, it is determined at step 617 if the distance to the object is between the minimum and maximum distances within the perimeter of the green. If not, the object distance is discarded at step 621. For each object distance within the minimum and maximum distances, it is optionally determined at step 619, if the heading associated with the object is within the cone of interest. If not, the object distance is discarded at step 621. If the heading is within the cone of interest, the object distance is displayed at step 623. The optional accelerometer 75 and gyrometer 80 may be used to more accurately provide heading information. If heading information is not used, then steps 609, 613 and 619 are not needed, and the object that is located at step 617 is reported.

Whereas in method 600 shown in FIG. 6, distance is first used as the filter and then the heading, in method 700 shown in FIG. 7, the heading may be the initial filter followed by distance. As before, the current location is calculated from GPS data at step 601. Stored coordinates for the golf course are accessed at step 603 to determine which hole on which golf course is associated with the location (step 605) and the maximum and minimum distances from the location to the perimeter of the green surrounding the particular hole (step 607), and further to establish a cone of interest to the green originating at the location (step 609). The laser is activated to emit pulses at step 611. Now to change the order of filtering, at step 613, a heading of the laser pulse is determined for each object using the GPS receiver (and optionally the accelerometer and a gyrometer). For each object, it is determined at step 619 if the heading associated with the object is within the cone of interest. If not, the object distance is discarded at step 621. The distances of the retained objects from the location are determined from the reflected lasers pulses at step 615. For each object with an associated heading that lies within the cone of interest, it is determined at step 617 if the distance to the object is between the minimum and maximum distances within the perimeter of the green. If not, the object distance is discarded at step 621. If the distance is within the minimum and maximum, the object distance is displayed at step 623.

Although the rangefinder and method for determining distances on a golf course have been described with reference to the United States' Global Positioning System (GPS), other space-based navigation systems could be substituted, such as the Russian Global Navigation Satellite System (GLONASS), the European Union's Galileo positioning system, or the like.

While FIGS. 1 and 2 illustrate the rangefinder 15 with a scope through which the user looks, a user may simply point and sweep the rangefinder 15 across the direction of the green. The method and structures described herein would still be able to calculate the distance to the pin flag 100. Therefore, the device need not have a scope to be operational, or the scope need not be used.

The invention has been described in connection with specific embodiments that illustrate examples of the invention but do not limit its scope. Various example systems have been shown and described having various aspects and elements. Unless indicated otherwise, any feature, aspect or element of any of these systems may be removed from, added to, combined with or modified by any other feature, aspect or element of any of the systems. As will be apparent to persons skilled in the art, modifications and adaptations to the above-described systems and methods can be made without departing from the spirit and scope of the invention, which is defined only by the following claims. Moreover, the applicant expressly does not intend the following claims “and the embodiments in the specification to be strictly coextensive.” Phillips v. AHW Corp., 415 F.3d 1303, 1323 (Fed. Cir. 2005) (en banc).

1. A distance measuring device, comprising:
a satellite navigation system receiver operable to determine a user's location;
a processor in communication with the receiver and linked to a database containing stored coordinates of at least one golf course;
a laser rangefinder operable to emit pulses toward the green and determine a distance between the location and each of a plurality of objects based on reflecting of the pulses from the objects, and provide the object distances to the processor;
wherein said processor is adapted to perform the following steps:
determining a golf course and a hole associated with location;
calculating a maximum green distance from the location to a back edge of the green containing the hole based on the stored coordinates;
calculating a minimum green distance from the location to a front edge of the green containing the hole based on the stored coordinates; and
discarding object distances based on the maximum and minimum green distances.

2. The device of claim 1, wherein the stored coordinates further comprise the left edge and right edge of the green, and wherein the satellite navigation system receiver determines a heading of the laser pulse for each object distance and provide the headings to the processor; wherein the processor is further adapted to perform the following steps:
calculating from the stored coordinates a cone of interest originating at the location and extending to the green, and
discarding object distances based on the cone of interest.

3. The device of claim 1, further comprising an accelerometer and a gyrometer operable to determine a heading of the laser pulse for each object distance and provide the headings to the processor; wherein the processor establishes from the stored coordinates a cone of interest originating at the location and extending to the green, and discards object distances based on the cone of interest.

4. The device of claim 1, wherein the processor outputs a non-discarded object distance to a display.

5. The device of claim 2, wherein the processor outputs a non-discarded object distance to a display.

6. The device of claim 3, wherein the processor outputs a non-discarded object distance to a display.

7. The device of claim 1, further comprising a power source for powering the receiver and a switch to turn off power to the receiver.

8. A method for measuring distances at a golf course, comprising:
calculating a user's location based on measurements of a satellite navigation system;
accessing a database of stored coordinates to determine a golf course and a hole associated with the location;
calculating from the stored coordinates and user location a maximum green distance green distance from the location to a back edge of the green associated with the hole;
calculating from the stored coordinates and user location a minimum green distance from the location to a front edge of the green associated with the hold,
activating a laser to send a plurality of pulses toward the green;
determining a distance between the location and each of a plurality of objects based on reflecting of the pulses from the objects;
comparing each object distance to the maximum and minimum green distances;
discarding the object distances based on the maximum and minimum green distances; and
displaying a non-discarded object distance.

9. The method of claim 8, further comprising:
accessing the database of stored coordinates to determine a left edge and right edge of the green associated with the hole;
calculating from the left and right edges of the green a cone of interest originating at the location and extending to the green;
determining a heading of the laser pulse for each object distance;
comparing the heading to the cone of interest;
discarding the object distances based on the cone of interest; and
displaying a non-discarded object distance.

10. The method of claim 8, further comprising outputting to a display the non-discarded object distance.

11. The method of claim 9, further comprising outputting to a display the non-discarded object distance.

12. The method of claim 8, further comprising disabling location calculations to save power.
